(19) United States
(12) Patent Application Publication
(10) Pub. No.: US 2007/0067953 A1
(43) Pub. Date: Mar. 29, 2007

(54) Monolithic structure with at least one elastic hinge

(75) Inventor: Johannes Petrus Martinus Bernardus Vermeulen, EINDHOVEN (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/576,320

(22) PCT Filed: Oct. 18, 2004
(86) PCT No.: PCT/IB04/52126

§ 371 Date: Apr. 18, 2006

(30) Foreign Application Priority Data
Oct. 21, 2003 (EP) 03103879.7

(51) Int. Cl. E05D 1/00

(52) U.S. Cl. 16/225

(57) ABSTRACT

Elastic hinges known from prior art separate the monolithic structure (18) in a rotating structural part (21) and a fixed structural part (20), in which the elastic hinge allows rotation of said rotating structural part relative to said fixed structural part. The elastic hinge is formed by forming at least one first slot-like element into said monolithic structure,in which the or each first slot-like element (2) defines the elastic hinge and thereby at least one rotation axis of the elastic hinge. The main drawback of such elastic hinges known from the prior art is the low transversal stiffness compared to the axial stiffness,especially for low tilting stiffness about the rotation axis. In order to provide an elastic hinge with increased transversal stiffness at least one rod-like or plate-like element (27) is formed into said monolithic structure (18) by forming at least one second slot-like element (23) into said monolithic structure (18).

The present invention is related to an elastic hinge and to a device comprising at least one elastic hinge. Further, the present invention is related to a method for the manufacture of an elastic hinge.

Hinges are used to enable displacements or rotations of a moving or rotating structural part relative to a fixed structural part. A large variety of hinges like roller bearings or sliding joints are known from the prior art. Play, friction and hysteresis effects limit the positioning performance of roller bearings and sliding joints.

In high-precision mechanisms and fixations elastic hinges are often used. Elastic hinges offer an accurate, reproducible and cost effective alternative over roller bearings and sliding joints. According to the prior art, an elastic hinge is formed into a monolithic structure by forming gaps or slots, possibly in combination with holes, into the monolithic structure thereby separating the monolithic structure into a fixed structural part and a rotating structural part except for the elastic hinge. The gaps or slots can be formed by a drilling process or by a wire EDM (Electro Discharge Machining) process.

U.S. Pat. No. 6,538,747 B1 discloses a phase shift adapter comprising a fixed end support portion and a moveable end support portion, whereby the fixed end support portion and the moveable end support portion are connected by integrally formed flexure hinges put in cascade to form an elastic mechanism. The two support portions are separated by slots formed in the monolithic structure of the phase shift adapter by a wire EDM process.

The drawback of elastic hinges known from prior art is the low transversal stiffness compared to the axial stiffness, which is the direction of the hinged part. Especially when a very low tilting stiffness is required, which according to the prior art is realized by a low dam-height to hole-diameter ratio, the transversal stiffness is very low. For this reason, elastic hinges can mainly be used for applications where the load direction or the direction of force coincides with the axial direction of the elastic hinge. For applications, where the load direction or the direction of force does not coincide with the axial direction of the elastic hinge, the elastic hinges according to the prior art would fail.

In order to solve that problem it is known from prior art to add for such applications a second elastic hinge perpendicular to the first elastic hinge to form a so-called cross-spring elastic hinge. However, adding a second elastic hinge requires an additional assembling process and results in a complex and expensive design. The main advantages of elastic hinges like simplicity, compactness and reproducibility get lost by forming such a cross-spring elastic hinge.

It is one object of the present invention to provide a new elastic hinge with improved transversal stiffness.

The present invention provides an elastic hinge formed into a monolithic structure, in which the elastic hinge separates the monolithic structure in a rotating structural part and a fixed structural part, and in which the elastic hinge allows rotation of said rotating structural part relative to said fixed structural part, said elastic hinge being formed by forming at least one first slot-like element into said monolithic structure, in which the or each first slot-like element defines the elastic hinge and thereby at least one rotation axis of the elastic hinge, and in which at least one rod-like or plate-like element is formed into said monolithic structure by forming at least one second slot-like element into said monolithic structure.

In accordance with a preferred embodiment of the invention the or each first slot-like element comprises at least two segments defining a plane, whereby the or each second slot-like element runs approximately parallel to one segment of a corresponding first slot-like element thereby defining a rod-like or plate-like element. The rotation axis of the elastic hinge runs approximately perpendicular to said plane defined by the segments of the or each first slot-like element.

Preferably the or each first and second slot-like elements are formed into said monolithic structure by a wire Electro Discharge Machining (EDM) process. Other manufacturing processes may be used, e.g. a micro-EDM process, an Electro Chemical Machining (ECM) process, a Laser Beam Machining (LBM) process, a Copper Vapor Laser (CVL) machining process or a so-called LIGA process.

The or each second slot-like element is most preferably formed into said monolithic structure by the same wire Electro Discharge Machining process used to form the or each first slot-like element into said monolithic structure.

Further on, the present invention provides a device comprising at least one elastic hinge. In addition, the present invention provides a method for manufacturing an elastic hinge.

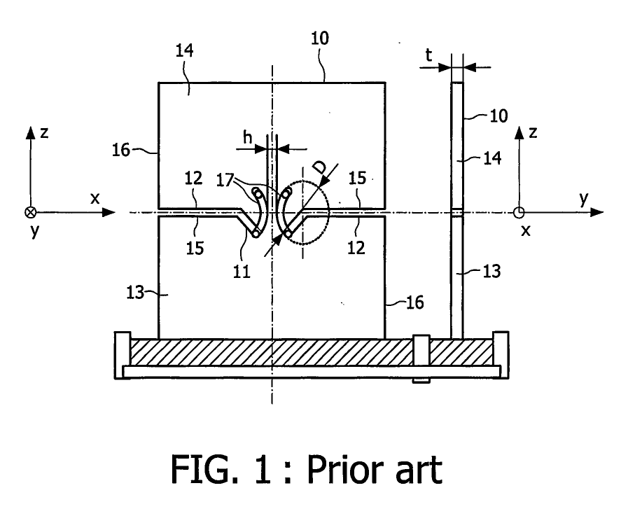

FIG. 1 shows an elastic hinge formed into a monolithic structure according to the prior art, separating the monolithic device into a fixed structural part and a rotating structural part;

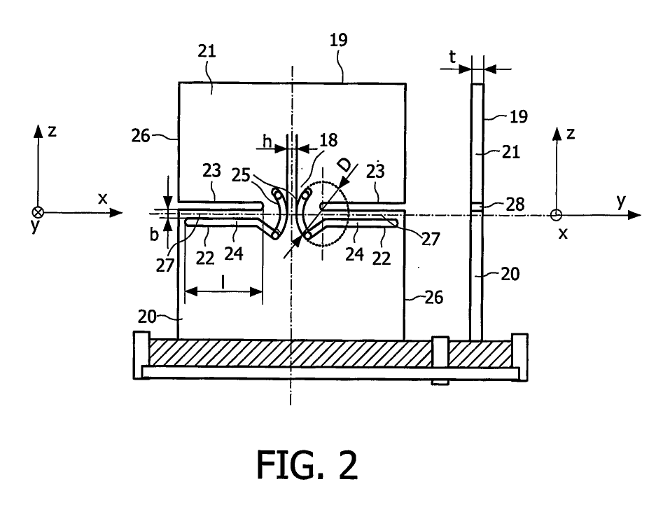

FIG. 2 shows an elastic hinge formed into a monolithic structure according to a first embodiment of the present invention, providing a two-dimensional elastic hinge for the rotation of the rotating structural part relative to the fixed structural part around one axis;

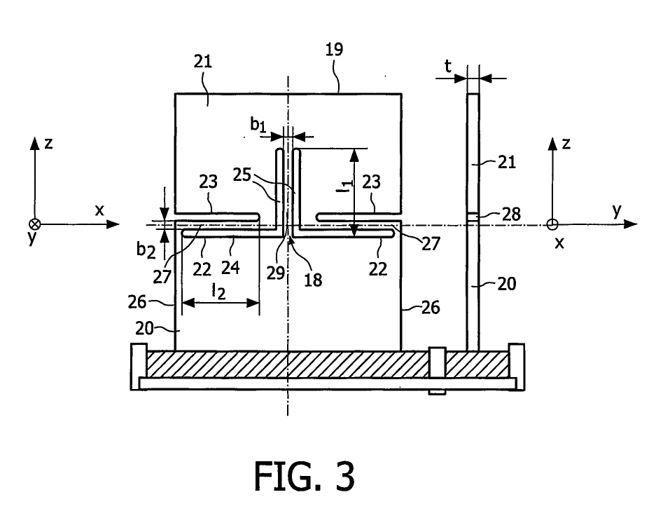

FIG. 3 shows an elastic hinge formed into a monolithic structure according to a second embodiment of the present invention, providing a two-dimensional elastic hinge for the rotation of the rotating structural part relative to the fixed structural part around one axis;

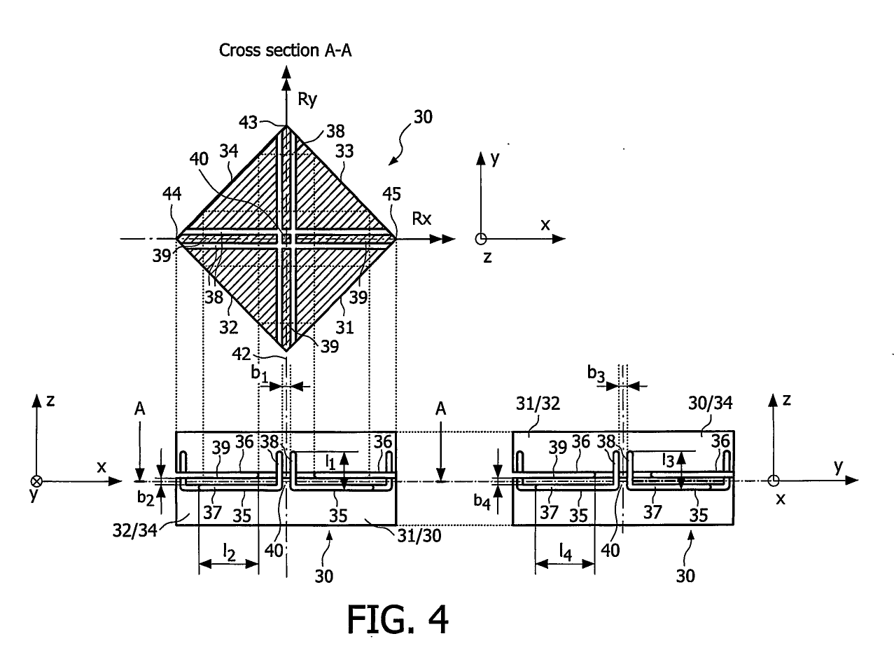

FIG. 4 shows an elastic hinge formed into a monolithic structure according to a third embodiment of the present invention, providing a three-dimensional elastic hinge for the rotation of the rotating structural part relative to said fixed structural part around two axes;

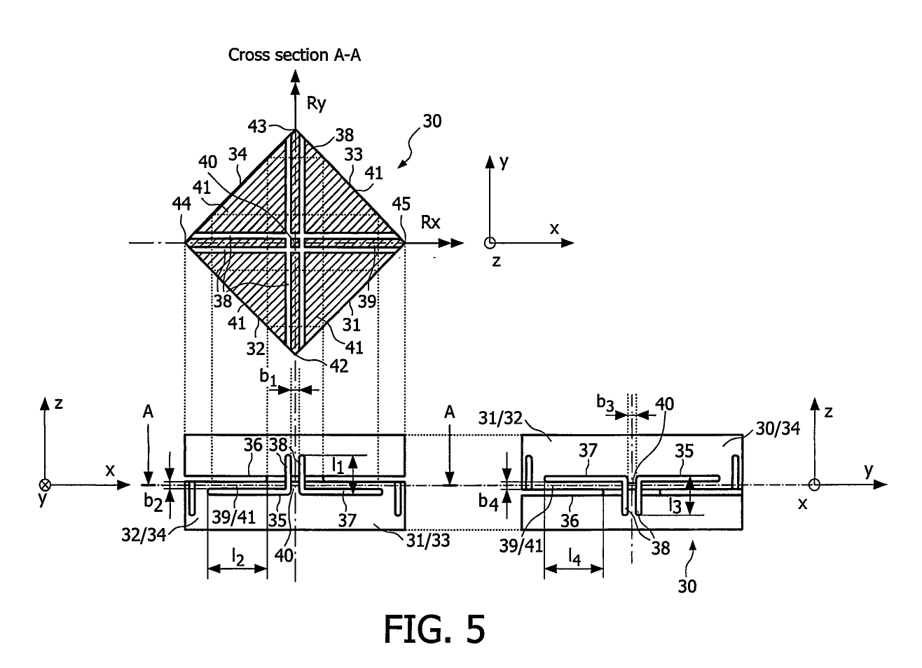

FIG. 5 shows an elastic hinge formed into a monolithic structure according to another embodiment of the present invention, providing a three-dimensional elastic hinge for the rotation of the rotating structural part relative to said fixed structural part around two axes; and

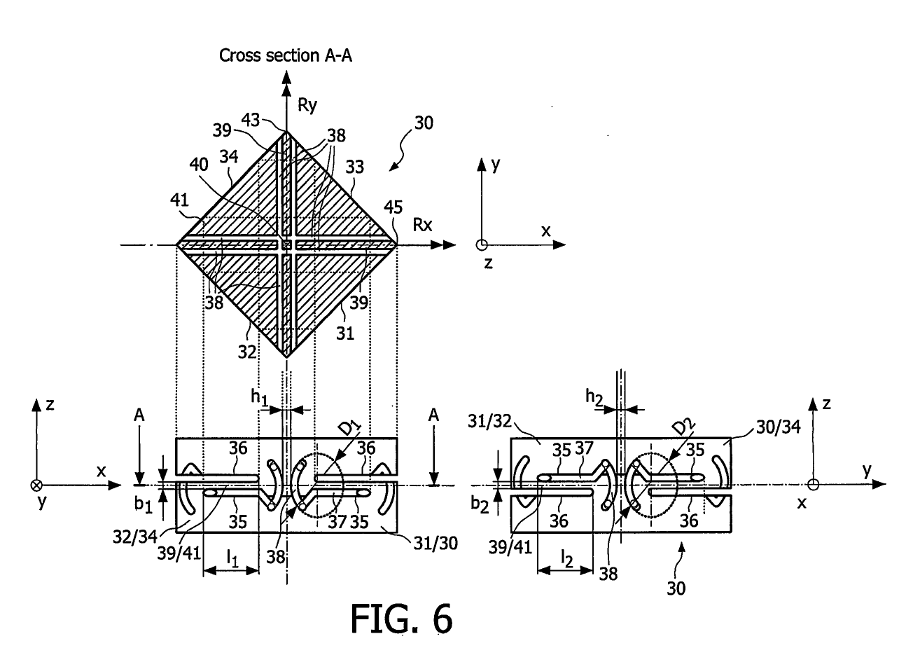

FIG. 6 shows an elastic hinge formed into a monolithic structure according to another embodiment of the present invention, providing a three-dimensional elastic hinge for the rotation of the rotating structural part relative to said fixed structural part around two axes.

FIG. 1 shows a monolithic structure in the form of a plate-like element 10 in two different views. On the left hand side of FIG. 1 a front view of the plate-like element 10 is shown, on the right hand side a side view of the plate-like element 10 is shown. The coordinate system shown on the left hand side of FIG. 1 relates to the front view and the coordinate system shown on the right hand side of FIG. 1 relates to the side view of the plate-like element 10. As shown in FIG. 1, the plate-like element 10 is characterized by the thickness t.

In the plate-like element 10 according to FIG. 1 an elastic hinge 11 is formed by two slot-like elements 12. According to the prior art, the slot-like elements 12 divide the monolithic plate-like element 10 in a fixed structural part 13 and in a rotating structural part 14. The two slot-like elements 12 remove the material of the plate-like element 10 over the entire thickness t of the plate-like element in the direction of the horizontal X-axis except for the elastic hinge 11 formed in the middle of the plate-like element 10. The elastic hinge 11 is defined by the material remaining between the two slot-like elements 12, whereby the distance between the two slot-like elements 12 in horizontal direction is characterized by the reference h in FIG. 1.

Both slot-like elements 12 of the elastic hinge 11 according to FIG. 1 are formed according to the prior art and comprise two segments. The first segments 15 of the two slot-like element 12 start at adjacent outer side walls 16 of the plate-like element 10 and are directed to the middle or center portion of the plate-like element 10 where the elastic hinge 11 is formed. These first segments 15 of the slot-like elements 12 run in the direction of the horizontal X-axis. The first segments 15 of each slot-like element 12 pass over into second segments 17 of the slot-like elements 12 in the center or middle portion of the plate-like element 10. It can be taken from FIG. 1 that the first segments 15 mainly separate the plate-like element 10 into the lower fixed structural part 13 and the upper rotating structural part 15, whereby the second segments 17 mainly define the elastic hinge 11. In FIG. 1, the second segments 17 are designed in the form of an circular arc, whereby the direction in which this circular arc is pointing or running is mainly the direction of the vertical Z-axis which is perpendicular to the horizontal X-axis. The diameter of the circular arc defined by each second segment 17 of the slot-like elements 12 is characterized by the reference D in FIG. 1. The two segments 15 and 17 of the slot-like elements 12 define a plane X-Z.

The elastic hinge 11 formed by the two slot-like elements 12 comprises a rotation axis which runs approximately perpendicular to the plane X-Z defined by the slot-like elements 12. In FIG. 1, the rotation axis of the elastic hinge 11 runs in the direction of the horizontal Y-axis, whereby this horizontal Y-axis is perpendicular to the X-axis and the Z-axis. The above described elastic hinge 11 formed in the monolithic plate-like element 10 allows a rotation of the upper structural part 14 relative to the lower structural part 13 around the Y-axis. The main drawback of the elastic hinge 11 according to the prior art described with reference to FIG. 1 is the relatively low transverse stiffness in the direction of the X-axis in comparison with the axial stiffness in the direction of the Z-axis. For this reason, the elastic hinge 11 according to the prior art is mainly useful for applications where the direction of forces coincides with the Z-axis. However, when the direction of force does not coincide with this direction and where forces in the direction of the X-axis occur, the elastic hinge 11 according to the prior art would fail because of its low transverse stiffness.

The present invention provides a new type of elastic hinge 11 formed into a monolithic structure having an improved transverse stiffness. FIGS. 2 to 6 show different embodiments of the elastic hinge according to the present invention.

FIG. 2 shows a first embodiment of the present invention in which an elastic hinge 18 is formed into a monolithic structure, whereby the monolithic structure is designed as a plate-like element 19. Like FIG. 1, FIG. 2 shows the plate-like element 19 in two different views, a front view being shown in the left hand portion of FIG. 2 and a side view being shown in the right hand portion of FIG. 2. The coordinate system shown in the left hand portion of FIG. 2 relates to the front view of the plate-like element 19 and the coordinate system shown in the right hand portion of FIG. 2 corresponds to the side view of the plate-like element 19.

The elastic hinge 18 separates the plate-like element 19 in a lower, fixed structural part 20 and in an upper, rotating structural part 21. The elastic hinge 18 is formed by slot-like elements, which will be described below in greater detail. A rotation axis of the elastic hinge 18 runs in the direction of the Y-axis in FIG. 2.

The elastic hinge 18 according to the present invention as shown in FIG. 2 is formed by a total of four slot-like elements, namely by a pair of first slot-like elements 22 and by a pair of second slot-like elements 23. The first slot-like elements 22 comprise two segments, a first segment 24 of said first slot-like elements 22 running in the direction of the horizontal X-axis and a second segment 25 of said first slot-like elements 22 running mainly in the direction of the vertical Z-axis, which is perpendicular to the horizontal X-axis. The first segments 24 are characterized by the length I and have the shape of a straight line in the front view on the left hand portion of FIG. 2. The second segments 25 are designed as circular arcs having a diameter D, where the circular arc is directed mainly in the direction of the vertical Z-axis. The distance between the two second segments 25 of the two first slot-like elements 22 in the center portion of the plate-like element 12 is characterized by the reference h in FIG. 2 and defines the elastic hinge in the center portion of the plate-like element 19. It can be taken from FIG. 2 that each first slot-like element 22 is formed into the monolithic structure of the plate-like element 19 in a way that the first slot-like elements 22 are completely surrounded by the monolithic structure in the direction of the X-axis and the Z-axis. This means that the first segments 24 of the first slot-like elements 22 do not extend through the outer side walls 26 of the plate-like element 19. Only in the direction of the rotating axis (Y-axis) do the first slot-like elements 22 extend to the exterior of the plate-like element 19.

According to the present invention, second slot-like elements 23 are formed into the plate-like element 19 adjacent to each first segment 24 of the first slot-like elements 22. The second slot-like elements 23 have the shape of a straight line in the front view in the left hand portion of FIG. 2. The second slot-like elements 23 extend approximately parallel to the first segments 24 of the first slot-like elements 22, the distance between the second slot-like element 23 and the corresponding first segment 24 of the corresponding first slot-like element 22 being characterized by the reference b in FIG. 2. By forming the second slot-like elements 23 into the plate-like element 19 rod-like elements 27 are formed. It can be taken from FIG. 2 that the second slot-like elements 23 run only in the direction of the horizontal X-axis and that the second slot-like elements 23 extend in the direction of the X-axis through the side walls 26 to the exterior of the plate-like element 19. An opening 28 of the second slot-like elements 23 in the side wall 26 is shown in the right hand portion of FIG. 2.

According to the present invention, the rod-like elements 27 are applied in the direction of the X-axis in addition to the hinged part of the elastic hinge 18 in the center portion or middle portion of the plate-like element 19. These rod-like elements 27 increase the transverse stiffness of the elastic hinge 18 in the direction of the X-axis. The elastic hinge 18 according to the present invention therefore provides sufficient stiffness in the direction of the Z-axis and in the direction of the X-axis.

FIG. 3 shows a second embodiment of the present invention. The embodiment of FIG. 3 is designed by analogy with the embodiment of FIG. 2. For this reason, in order to avoid repetitions, the same reference numerals are used for the same structural and functional elements.

The embodiment of FIG. 3 differs from the embodiment in FIG. 2 by the shape of the second segments 25 of the first slot-like elements 22. In the embodiment according to FIG. 3 the second segments 25 are designed in the form of a straight line and not in the form of a circular arc. For this reason, in addition to the rod-like elements 27 defined by the first segments 24 of the first slot-like element 22 and the second slot-like elements 23, an additional rod-like dement 29 is formed between the second segments 25 of the two first slot-like elements 22. The additional rod-like element 29 extends in the direction of the vertical Z-axis and extends therefore approximately perpendicularly to the direction of the rod-like elements 27 extending in the direction of the horizontal X-axis. The length of the rod-like elements 27 are characterized by the reference 12 and the width is characterized by the reference b₂. The length of the additional rod-like element 29 is characterized by the reference I₁ and the width by the reference b₁. The additional rod-like element 29 running in the direction of the vertical Z-axis further decreases the tilting stiffness of the elastic hinge 18 about the Y-axis provided an equal axial stiffness in the direction of the Z-axis compared to the embodiment according to FIG. 2. The embodiment according to FIG. 3 provides a new type of a cross-spring elastic hinge which is unlike the solutions know from prior art monolithic and therefore compact and free of hysteresis.

The embodiments of the present invention described with reference to FIGS. 2 and 3 provide both a two-dimensional elastic hinge for the rotation of the rotating structural part relative to the fixed structural part around one axis. However, the present invention also covers embodiments providing a three-dimensional elastic hinge for the rotation of the rotating structural part relative to the fixed structural part around two axes and consequently around an arbitrary axis in the plane defined by said two axes. FIGS. 4 to 6 illustrate embodiments of such three-dimensional elastic hinges.

FIG. 4 shows an embodiment of the present invention providing a three-dimensional elastic hinge. In the embodiment of FIG. 4 the elastic hinge is formed in monolithic structure in the form of a cube-like element 30, whereby FIG. 4 shows three different views of the cube-like element 30. In the lower part of FIG. 4 two different side views (X-Z view and Y-Z view) of the cube-like element 30 are shown and in the upper part of FIG. 4 a cross-sectional view (X-Y view) through the cube-like element 30 in A-A direction is shown. Beside each of the different views a corresponding coordinate system is shown.

The cube-like element 30 according to FIG. 4 comprises four side walls 31, 32, 33 and 34. Into each of said side walls 31, 32, 33 and 34 two slot-like elements are formed, namely a first slot-like element 35 and a second slot-like element 36. Each of the first slot-like elements 35 comprises two segments, a first segment 37 running in horizontal direction, namely in the direction of the horizontal X-axis or Y-axis, and a second segment 38 running the direction of the vertical Z-axis. It can be taken from the cross-sectional view (X-Y view) of FIG. 4 that the second segments 38 extend from a first corner 42/44 to an adjacent second corner 43/45 of the cube-like element 30. The first segments 37 extend between two adjacent side walls 31 and 33 or 32 and 34. The second slot-like elements 36 run approximately parallel to the first segments 37 of said first slot-like elements 35, whereby a rod-like or plate-like element 39 is formed between the first segments 37 of the first slot-like elements 35 and the second slot-like elements 36. The rod-like or plate-like elements 39 have the shape of a rectangle in the cross-sectional view and connect the fixed structural part and the rotating structural part of the elastic hinge only in horizontal direction. Another rod-like element 40 is formed in the center between the second segments 38 of adjacent first slot-like elements 35. The rod-like element 40 has the shape in the cross-sectional view of a square and connects the fixed structural part and the rotating structural part of the elastic hinge in vertical direction.

The rod-like elements 39 running in horizontal direction are characterized by their length I₂ or I₄ and their width b₂ or b₄. The rod-like element 40 running in vertical direction is characterized by its lengths I₁ and I₃ and its width by b₁ and b₃.

The embodiments of the three-dimensional elastic hinge shown in FIGS. 5 and 6 are designed by analogy with the embodiment of FIG. 4. For this reason, in order to avoid repetitions, the same reference numerals are used for the same structural and functional elements.

The embodiment of FIG. 5 differs from the embodiment according to FIG. 4 by the orientation of the slot-like elements 35 and 36. In the embodiment according to FIG. 5 the slot-like elements 35 and 36 are mirrored (in the Y-Z view but not in the X-Z view) in the direction of the Y-axis compared to the embodiment according to FIG. 4. In the embodiment of FIG. 4, the torsional stiffness around the vertical Z-axis of the upper rotating structural part relative to the lower fixed structural part is relatively low because of the fact that only the four rod-like elements 39 and the rod-like element 40 interconnect the upper rotating structural part to the lower fixed structural part. In the embodiment of FIG. 5 four triangular plate-like elements 41 connect the upper rotating structural part to the lower fixed structural part as well, thereby providing higher torsional stiffness around the vertical Z-axis. In the embodiment of FIG. 5, the four rod-like elements 39 and the four triangular plate-like elements 41 connect the upper rotating structural part to the lower fixed structural part in horizontal direction. The rod-like element 40 in the center connects the upper rotating structural part to the lower fixed structural part in vertical direction.

The embodiments of the three-dimensional hinges shown in FIGS. 4 and 5 correspond (in view of the shape of the slot-like elements) to the two-dimensional hinge shown in FIG. 3. The three-dimensional elastic hinge according to FIG. 6 corresponds (in view of the shape of the slot-like elements) to the two-dimensional elastic hinge shown in FIG. 2. The shape of the first slot-like elements 35 of the embodiment according to FIG. 6 corresponds to the shape of the first slot-like elements 22 of the embodiment in FIG. 2, whereby the second segments 38 of these first slot-like elements 35 do not have the shape of a straight line but the shape of a circular arc. From a functional point of view the embodiment of FIG. 6 is similar to the embodiment of FIG. 5, having four rod-like elements 39 and the four triangular plate-like elements 41 connecting the upper rotating structural part to the lower fixed structural part in horizontal direction, and one rod-like element 40 in the center connecting the upper rotating structural part to the lower fixed structural part in vertical direction.

The three-dimensional elastic hinges provided by the embodiments according to FIGS. 4 to 6 provide all rotations of the upper rotating structural part relative to the lower fixed structural part around the two horizontal axes, namely the X-axis and the Y-axis.

According to the present invention, all slot-like elements are formed in the monolithic structures provided by the plate-like element 19 or the cube-like element 30 by a wire Electrical Discharge Machining (EDM) process. This allows a very compact design of a device comprising the elastic hinges according to the invention. All slot-like elements can be formed during the same EDM-process. For this reason, manufacturing is simple and devices comprising the elastic hinges according to the invention can be provided at low costs. Other manufacturing processes may be used, e.g. a micro-EDM process, an Electro Chemical Machining (ECM) process, a Laser Beam Machining (LBM) process, a Copper Vapor-Laser (CVL) machining process or a so-called LIGA process.

The elastic hinges according to the present invention can be used in any kind of elastic mechanism or elastic fixation where improved or increased transverse stiffness is required. An example is that the elastic hinges can be used in kinematic fixations for high-precision optical components. Other fields of application for the present invention are high-precision coordinate measuring machines for measuring small products, hysteresis-free elastic joints as a more accurate alternative compared to sliding or rolling joints and self-aligning supports, for example aerostatic bearing systems.

### LIST OF REFERENCE NUMERALS

10 plate-like element
11 elastic hinge
12 slot-like element
13 fixed structural part
14 rotating structural part
15 first segment
16 second segment
17 sidewall
18 elastic hinge
19 plate-like element
20 fixed structural part
21 rotating structural part
22 first slot-like element
23 second slot-like element
24 first segment
25 second segment
26 sidewall
27 rod-like element
28 opening
29 rod-like element
30 cube-like element
31 side wall
32 side wall
33 side wall
34 side wall
35 first slot-like element
36 second slot-like element
37 first segment
38 second segment
39 rod-like element
40 rod-like element
41 triangler plate-like element
42 corner
43 corner
44 corner
45 corner

1. Elastic hinge formed into a monolithic structure (18), whereby the elastic hinge separates the monolithic structure (18) in a rotating structural part (21) and a fixed structural part (20), and whereby the elastic hinge allows rotation of said rotating structural part (21) relative to said fixed structural part (20), said elastic hinge being formed by forming at least one first slit-like element (22) into said monolithic structure (18), whereby the or each first slit-like element (22) defines the elastic hinge and thereby at least one rotation axis (Y) of the elastic hinge, characterized in that at least one rod-like or plate-like element (27) is formed into said monolithic structure (18) by forming at least one second slit-like element (23) into said monolithic structure (18).

2. Elastic hinge according to claim 1, characterized in that the or each first slit-like element (22) comprises at least two segments (24, 25) defining a plane (X-Z), whereby the or each second slit-like element (23) runs approximately in parallel to one segment (24) of a corresponding first slit-like element (22) thereby defining a rod-like or plate-like element (27).

3. Elastic hinge according to claim 2, characterized in that the displacement or rotation axis (Y) of the elastic hinge runs approximately perpendicular to said plane (X-Z).

4. Elastic hinge according to claim 1, characterized in that the or each first slit-like element (22) comprises at least two segments, whereby a first segment (24) runs in the direction of a first axis (X) and a second segment (25) runs mainly in the direction of a second axis (Z) being perpendicular to said first axis (X), and whereby the rotation axis (Y) of the elastic hinge runs in a direction perpendicular to said plane (X-Z) defined by the first axis (X) and the second axis (Z).

5. Elastic hinge according to claim 1, characterized in that the or each first slit-like element (22) is formed into said monolithic structure (18) in a way that the or each first slit-like element (22) does only extend to the exterior of the monolithic structure (18) in the direction of the rotation axis (Y) of the elastic hinge, whereby the first slit-like element (22) is completely surrounded by the monolithic structure (18) in the direction of the axis (X, Z) defining said plane (X-Z).

6. Elastic hinge according to claim 1, characterized in that the or each second slit-like element (23) is formed into said monolithic structure (18) in a way that the or each second slit-like element (23) extends to the exterior of the monolithic structure (18) in the direction of the rotation axis (Y) of the elastic hinge and in the direction of one axis (X) defining said plane (X-Z).

7. Elastic hinge according to claim 1, characterized in that the or each first and second slit-like elements (22, 23) are formed into said monolithic structure by a wire Electro Discharge Machining process.

8. Elastic hinge according to claim 7, characterized in that the or each second slit-like element (23) is formed into said monolithic structure by the same wire Electro Discharge Machining process used to form the or each first slit-like element (22) into said monolithic structure.

9. Device comprising at least one elastic hinge formed into a monolithic structure (18) of said device, whereby the or each elastic hinge separates the monolithic structure in a rotating structural part (21) and a fixed structural part (20), and whereby the elastic hinge allows rotation of said rotating structural part relative to said fixed structural part, said elastic hinge being formed by forming at least one first slit-like element (22) into said monolithic structure, whereby the or each first slit-like element (22) defines the elastic hinge and thereby at least one rotation axis (Y) of the elastic hinge, characterized in that at least one rod-like or plate-like element (27) is formed into said monolithic structure (18) by forming at least one second slit-like element (23) into said monolithic structure (18).

10. Device comprising at least one elastic hinge formed into a monolithic structure (18) of said device, whereby the or each elastic hinge separates the monolithic structure in a rotating structural part (21) and a fixed structural part (20), and whereby the elastic hinge allows rotation of said rotating structural part relative to said fixed structural part, said elastic hinge being formed by forming at least one first slit-like element (22) into said monolithic structure, whereby the or each first slit-like element (22) defines the elastic hinge and thereby at least one rotation axis (Y) of the elastic hinge, characterized in that at least one rod-like or plate-like element (27) is formed into said monolithic structure (18) by forming at least one second slit-like element (23) into said monolithic structure (18) characterized in that the or each elastic hinge is formed according to claim 2.

11. Method for manufacturing an elastic hinge into a monolithic structure, whereby the elastic hinge separates the monolithic structure in a rotating structural part and a fixed structural part, and whereby the elastic hinge allows rotation of said rotating structural part relative to said fixed structural part, by performing the following steps:
a) providing a monolithic structure,
b) forming at least one first slit-like element into said monolithic structure, thereby defining an elastic hinge, whereby said elastic hinge defines at least one rotation axis (Y) of the elastic hinge,
c) forming at least one rod-like or plate-like element into said monolithic structure by forming at least one second slit-like element into said monolithic structure.

12. Method according to claim 11, characterized in that the or each first slit-like element will be formed in a way that the or each first slit-like element comprises at least two segments, whereby a first segment runs in the direction of a first axis (X) and a second segment runs mainly in the direction of a second axis (Z) being perpendicular to said first axis (X), and whereby the rotation axis (Y) of the elastic hinge runs in a direction perpendicular to said plane (X-Z) defined by the first axis (X) and the second axis (Z).

13. Method according to claim 12, characterized in that the or each second slit-like element will be formed in a way the or each second slit-like element runs approximately in parallel to one segment of a corresponding first slit-like element thereby defining a rod-like or plate-like element.

14. Method according to claim 11, characterized in that the or each first slit-like element will be formed into said monolithic structure in a way that the or each first slit-like element does only extend to the exterior of the monolithic structure in the direction of the rotation axis (Y) of the elastic hinge, whereby the or each first slit-like element is completely surrounded by the monolithic structure in the direction of the axis (X, Z) defining said plane (X-Z).

15. Method according to claim 11, characterized in that the or each second slit-like element is formed into said monolithic structure in a way that the or each second slit-like element extends to the exterior of the monolithic structure in the direction of the rotation axis (Y) of the elastic hinge and in the direction of one axis (X) defining said plane (X-Z).

16. Method according to claim 11, characterized in that the or each first and second slit-like elements will be formed into said monolithic structure by a wire Electro Discharge Machining process.
